(19) United States
(12) Patent Application Publication
(10) Pub. No.: US 2008/0004732 A1
(43) Pub. Date: Jan. 3, 2008

(54) AUDIO REPRODUCING APPARATUS

(75) Inventors: Kiyoshi Hoshino, Tokyo (JP); Koichi Chiba, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/769,264

(22) Filed: Jun. 27, 2007

(30) Foreign Application Priority Data
Jun. 30, 2006 (JP) 2006-181036

(51) Int. Cl. G06F 17/00

(52) U.S. Cl. 700/94

(57) ABSTRACT

In an audio reproducing apparatus, when an information button is depressed during reproduction of a compressed music piece file, a control portion issues an instruction to reproduce a music piece information audio file associated with the compressed music piece file from a management information file. After completion of the reproduction of the music piece information audio file, it is confirmed whether or not the reproduction of the music piece is completed. When the reproduction of the compressed music piece file is completed, an operation is completed.

### BACKGROUND

1. Field

One embodiment of the invention relates to an audio reproducing apparatus for converting music piece information into an audio file in the outside, and reproducing the resulting audio file, thereby reporting the music piece information to a user.

2. Description of the Related Art

For example, an audio reproducing apparatus for converting music piece information into audio information in its inside, and reporting the music piece information in the form of a sound to a user in accordance with the audio information before the music piece with which the music piece information is associated is reproduced is known as conventional one. This audio reproducing apparatus, for example, is disclosed in the Japanese Patent Kokai No. 2001-210065.

In the case of the conventional audio reproducing apparatus, when a user records a music piece to which he/she desires to listen in the conventional audio reproducing apparatus, accompanying information, such as a title and an artist name of the music piece, accompanying the music piece is converted into audio information in an inside of the conventional audio reproducing apparatus. Also, when the music piece concerned is reproduced, the audio information is reproduced as the original music piece information in a head of the music piece concerned. As a result, even when the user does not look at a displaying portion of the conventional audio reproducing apparatus, he/she can know the accompanying information.

In the conventional audio reproducing apparatus, however, since the music piece information is merely reproduced before reproduction of the music piece, the user cannot know the music piece information at an arbitrary time. In addition, since the accompanying information accompanying the music piece is converted into the audio information in the inside of the conventional audio reproducing apparatus, a control portion having a high throughput must be included, which causes the cost to increase.

### BRIEF DESCRIPTION OF THE SEVERAL VIEWS OF THE DRAWINGS

A general architecture that implements the various features of the invention will now be described with reference to the drawings. The drawings and the associated descriptions-are provided to illustrate embodiments of the invention and not to limit the scope of the invention.

FIGS. 1A and 1B are respectively a front view and a side view of an audio reproducing apparatus according to an embodiment of the invention;

FIG. 2 is a block diagram showing a configuration of the audio reproducing apparatus according to the embodiment of the invention;

FIG. 3 is a block diagram showing a structure of software in the audio reproducing apparatus according to the embodiment of the invention;

FIG. 4 is a flow chart showing an operation for generating a music piece file by using a PC in the audio reproducing apparatus according to the embodiment of the invention;

FIG. 5 is a flow chart showing an operation for registering music piece information in the audio reproducing apparatus according to the embodiment of the invention;

FIG. 6 is a block diagram showing a schematic structure of a management information file in the audio reproducing apparatus according to the embodiment of the invention;

FIG. 7 is a flow chart showing an operation for reproducing a music piece information audio file in the audio reproducing apparatus according to the embodiment of the invention;

FIG. 8 is a flow-chart showing an operation for reproducing the music piece information audio file in a phase of stop of reproduction of a compressed music piece file in the audio reproducing apparatus according to the embodiment of the invention; and

FIG. 9 is a flow chart showing an operation for reproducing the music piece information audio file in a phase of the reproduction of the compressed music piece file in the audio reproducing apparatus according to the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided an audio reproducing apparatus, including: a communicating portion for transmitting/receiving a music piece file, and a music piece information audio file having audio information, music piece information accompanying the music piece file being converted into the audio information; a memory portion for storing therein the music piece file and the music piece information audio file; a reproducing portion for reproducing the music piece file and the music piece information audio file, and outputting a resulting regenerative signal; and a sound outputting portion for outputting the regenerative signal in a form of a sound.

With this constitution, it is unnecessary to convert the accompanying information into the audio information in the inside of the audio reproducing apparatus. As a result, the audio reproducing apparatus can be made without using a control portion having a high throughput.

According to a further embodiment of the invention, there is provided an audio reproducing apparatus, including: a communicating portion for transmitting/receiving a music piece file having, and a music piece information audio file having audio information, music piece information accompanying the music piece file being converted into the audio information; a memory portion for storing therein the music piece file and the music piece information audio file; a music piece information-reproducing button, an instruction to reproduce the music piece information audio file being issued by using the music piece information-reproducing button; a reproducing portion for reproducing the music piece file, and reproducing the music piece information audio file in accordance with the instruction for reproduction, thereby outputting a regenerative signal; and a sound outputting portion for outputting the regenerative signal in a form of a sound.

With this constitution, a user can know the accompanying information at an arbitrary time at which he/she desires to know the music piece information accompanying the audio information file by using the dedicated button.

According to a still further embodiment of the invention, there is provided an audio reproducing apparatus, including: a communicating portion for transmitting/receiving a music piece file, and a music piece information audio file through a communication with an external computer, the music piece information audio file being generated in accordance with the music piece file in the external computer and having audio information, music piece information on the music piece file being converted into the audio information; a memory portion for storing therein the music piece file and the music piece information audio file; a music piece information-reproducing button, an instruction to reproduce the music piece information audio file being issued by using the music piece information-reproducing button; a reproducing portion for reproducing the music piece file and the music piece information audio file in accordance with the instruction for reproduction, thereby outputting a regenerative signal; and a sound outputting portion for outputting the regenerative signal in a form of a sound.

With this constitution, since the music piece information audio file can be generated in the external computer, it is unnecessary for the audio reproducing, apparatus to have a construction for generating the music piece information file, and thus the audio reproducing apparatus can be miniaturized.

According to the invention, the audio reproducing apparatus is provided with which the user can know the accompanying information in accordance with the music piece information at an arbitrary time at which he/she desires to know the accompanying information by using the dedicated button.

An audio reproducing apparatus according to an embodiment of the invention will be described in detail hereinafter with reference to the accompanying drawings.

### [Construction of Audio Reproducing Apparatus]

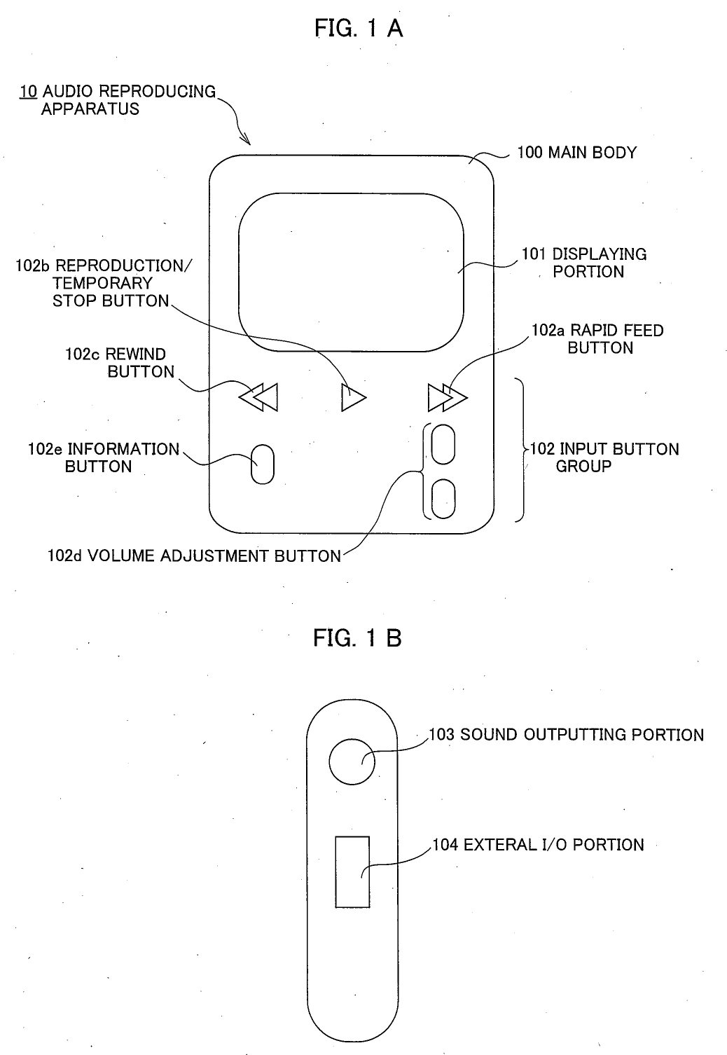

FIG. 1A is a front view showing a schematic construction of an audio reproducing apparatus according to an embodiment of the invention.

The audio reproducing apparatus 10 includes a main body 100 which has a control portion and the like constituted by electronic components in its inside, a displaying portion 101 for displaying thereon a music piece name, an artist name and the like of a music piece, and an input button group 102 with which reproduction, adjustment of a volume, and the like are performed.

The input button group 102 has a rapid feed button 102a with which a music piece is rapidly fed, a reproduction/temporary stop button 102b with which the music piece is reproduced or the reproduction of the music piece is temporarily stopped, a rewind button 102c with which the music piece is rewound, a volume adjustment button 102d with which a volume of the music piece is adjusted, and an information button 102e with which a music piece information audio file 603 (described later) is reproduced.

FIG. 1B is a side view showing a schematic construction of the audio reproducing apparatus according to the embodiment of the invention.

The audio reproducing apparatus 10 includes a sound outputting portion 103 for transmitting a regenerative signal to the outside, and a communicating portion 104 for communicating with an external apparatus such as a personal computer (PC) 30.

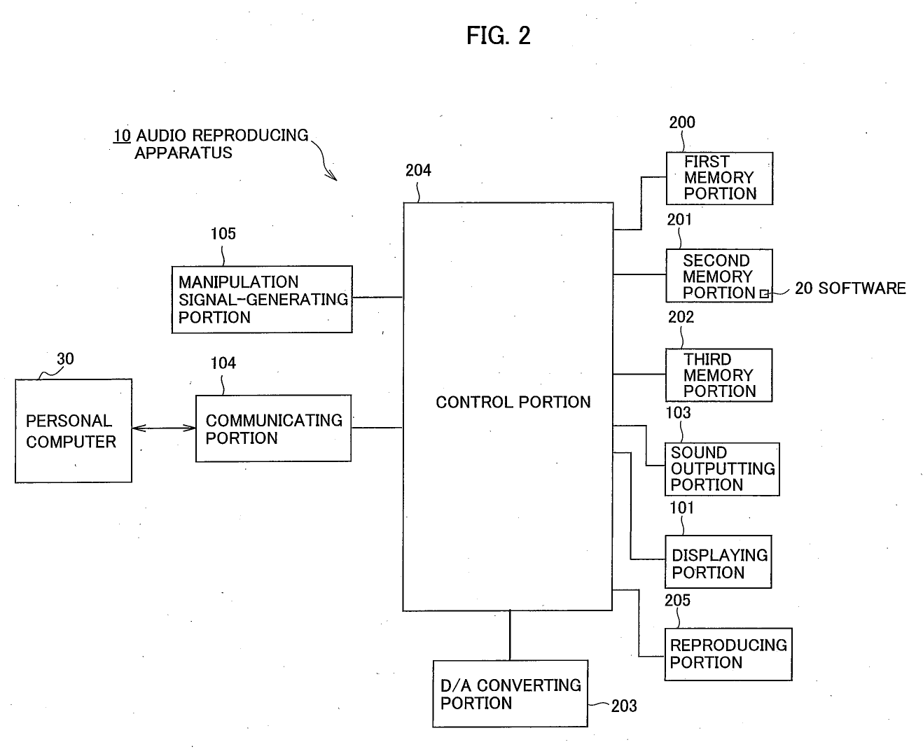

FIG. 2 is a block diagram showing a schematic configuration of the audio reproducing apparatus according to the embodiment of the invention.

The audio reproducing apparatus 10 includes a manipulation signal-generating portion 105 for outputting a manipulation signal by manipulating the input button group 102, a communicating portion 104 for transmitting/receiving a compressed music piece file 602 or the like to/from the PC 30 as the external apparatus through a communication with the PC 30, a first memory portion 200 for storing therein the compressed music piece file 602 or the like obtained through the communication with the PC 30 as the external apparatus, a second memory portion 201 for storing therein software 20 or the like, a third memory portion 202 for temporarily storing information on an operational state or the like of a control portion 204, a D/A converting portion 203 for converting a digital signal into an analog signal, and outputting the resulting analog signal, the control portion 204 for generally managing reproduction and the like of a music piece, a reproducing portion 205 for reproducing the compressed music piece file 602 or the like, and outputting a resulting regenerative signal, a sound outputting portion 103 for transmitting the regenerative signal to the outside, and a displaying portion 101 for displaying thereon a music piece name, an artist name and the like of a music piece.

### [Structure of Software]

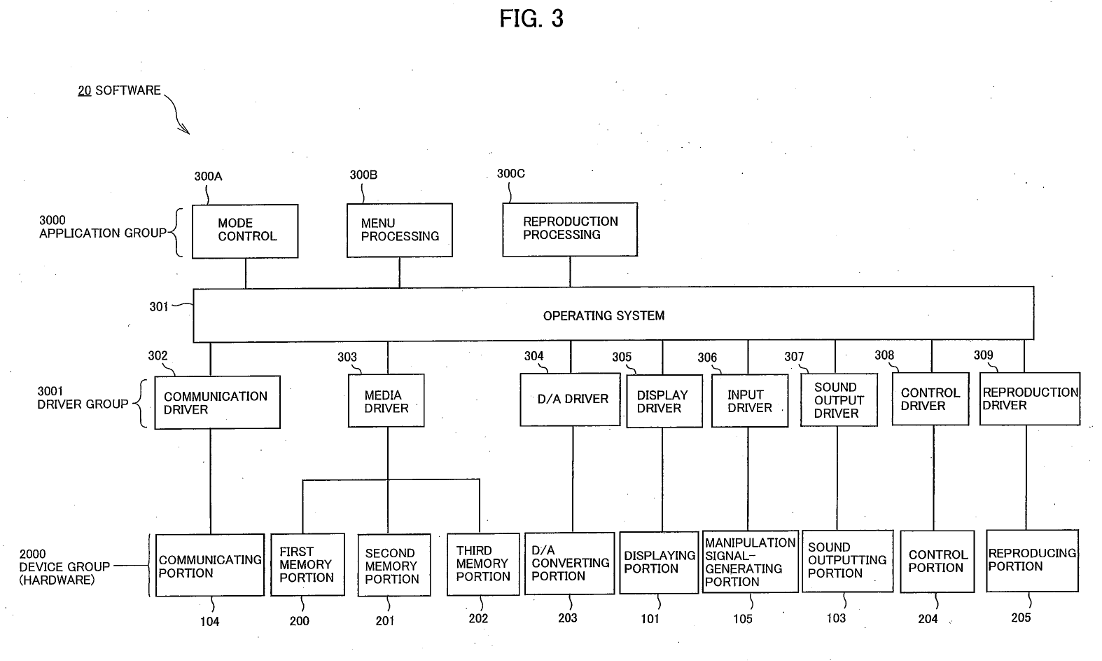

FIG. 3 is a block diagram showing a schematic structure of the software preserved in the second memory portion of the audio reproducing apparatus according to the embodiment of the invention.

The software 20 includes an application group 3000, an operating system 301, and a driver group 3001. Also, a device group 2000 as hardware having the portions 104 to 205 which correspond to drivers 302 to 309, respectively, is connected to the software 20. The software 20 is stored in the second memory portion 201, and is executed by the control portion 204 to operate the audio reproducing apparatus 10.

The application group 3000 has a mode control application 300A for controlling reproduction or the like of a music piece, a menu processing application 300B for processing various kinds of menu items, and a reproduction processing application 300C for executing processing for expanding the compressed music piece file 602, or the like.

The operating system 301 generally manages the application group 3000 and the driver group 3001.

The driver group 3001 includes a communication driver 302 for managing the communicating portion 104, a media driver 303 for managing each of the first, second and third memory portions 200, 201 and 202, a D/A driver 304 for managing the D/A converting portion 203, a display driver 305 for managing the displaying portion 101 for displaying thereon a music piece name, an artist name and the like of a music piece, an input driver 306 for managing the manipulation signal-generating portion 105, a sound output driver 307 for managing the sound outputting portion 103, a control driver 308 for managing the control portion 204, and a reproduction driver 309 for managing the reproducing portion 205.

### [Operation of Audio Reproducing Apparatus]

An operation of the audio reproducing apparatus according to the embodiment of the invention will be described in detail hereinafter with reference to FIGS. 1A and 1B to FIG. 9.

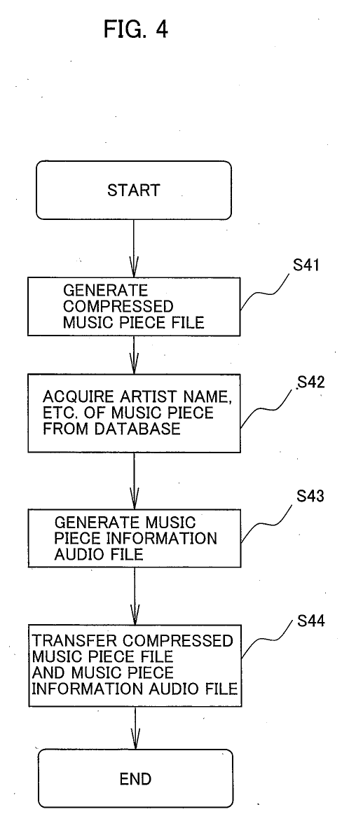

FIG. 4 is a flow chart showing an operation for generating a compressed music piece file by using the PC in the audio reproducing apparatus according to the embodiment of the invention.

A music piece file about a CD or the like which a user desires to take in the audio reproducing apparatus 10 is generated in the form of a compressed music piece file 602 by using the PC 30 (Step S41). Music piece information, as accompanying information, which is associated with the compressed music piece file 602 thus taken in the audio reproducing apparatus 10 and which is stored in the form of a text in a database on the Internet is acquired from the database on the Internet (Step S42). The music piece information which is associated with the compressed music piece file 602 and which is stored in the form of the text in the database on the Internet is converted into audio information by using a sound synthesizing function provided in the PC 30, thereby generating a music piece information audio file 603 (Step S43). Both the music piece information audio file 603 thus generated, and the compressed music piece file 602 are transferred from the PC 30 to the sound reproducing apparatus 10, thereby completing the operation for generating the compressed music piece file 602 by using the PC 30.

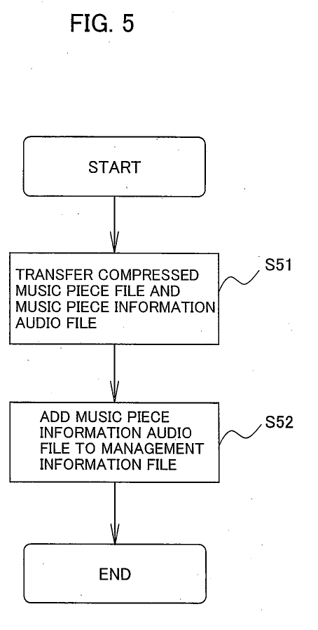

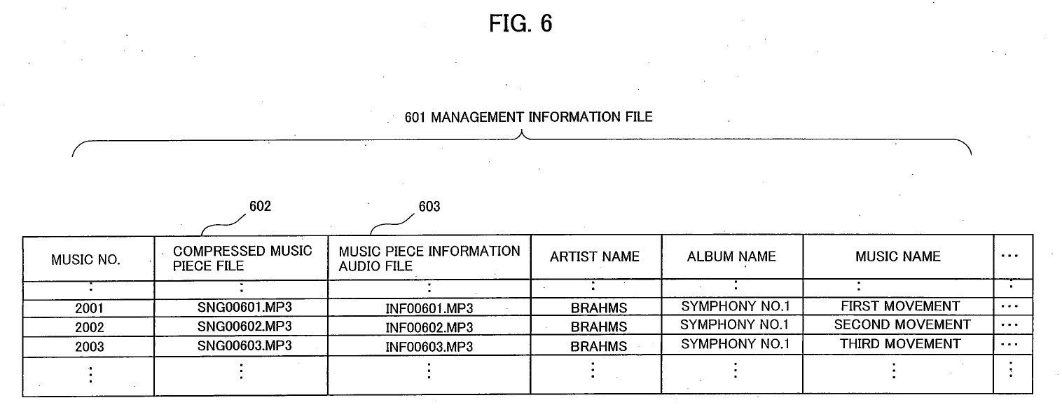

FIG. 5 is a flow chart showing an operation for registering the music piece information audio file in the audio reproducing apparatus according to the embodiment of the invention. This operation will now be described with reference to a block diagram of FIG. 6 as well showing a schematic structure of a management information file.

The music piece information, such as the compressed music piece file 602 and the music piece information audio file 603, which is generated by using the PC 30 is transferred to the audio reproducing apparatus 10 (Step S51). A music name, an artist name and the like of a music piece are associated with the compressed music piece file 602 in accordance with the music piece information thus transferred, and the music piece information audio file 603 is then added to the management information file 601, thereby completing this operation (Step S52). As a result, the management information file 601 is arranged so as to be associated with the compressed music piece file 602 as shown in FIG. 6.

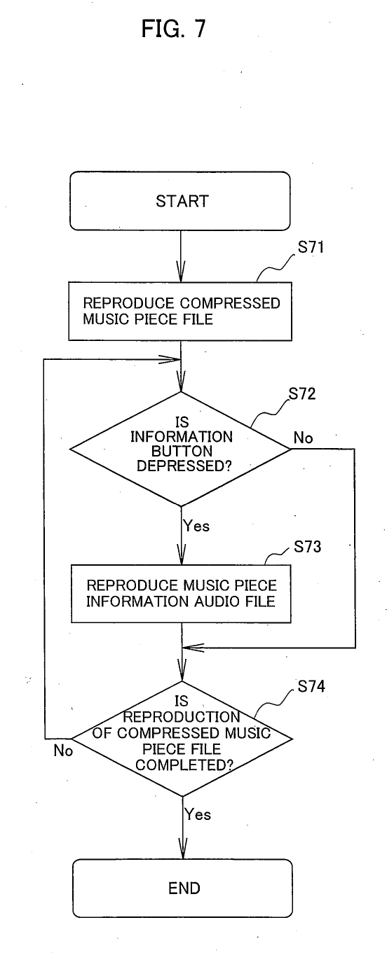

FIG. 7 is a flow chart showing an operation for reproducing the music piece information audio file in the audio reproducing apparatus according to the embodiment of the invention.

When the user depresses the information button 102e (Step S72: YES) during the reproduction of the compressed music piece file 602 (Step S71), the control portion 204 reproduces the music piece information audio file 603 associated with the compressed music piece file 602 from the management information file 601 (Step S73).

On the other hand, when the user depresses no information button 102e in Step S72 (Step S72: NO), the operation proceeds to processing in Step S74.

After completion of the reproduction of the music piece information audio file 603, it is confirmed whether or not the reproduction of the compressed music piece file 602 is completed. When it is confirmed that the reproduction of the compressed music piece file 602 is completed (Step S74: YES), this operation is completed.

On the other hand, when it is confirmed in Step S74 that no reproduction of the compressed music piece file 602 is completed (Step S74: NO), the operation returns back to the processing in Step S72, and the processing in and after the processing in Step S72 is repeatedly executed.

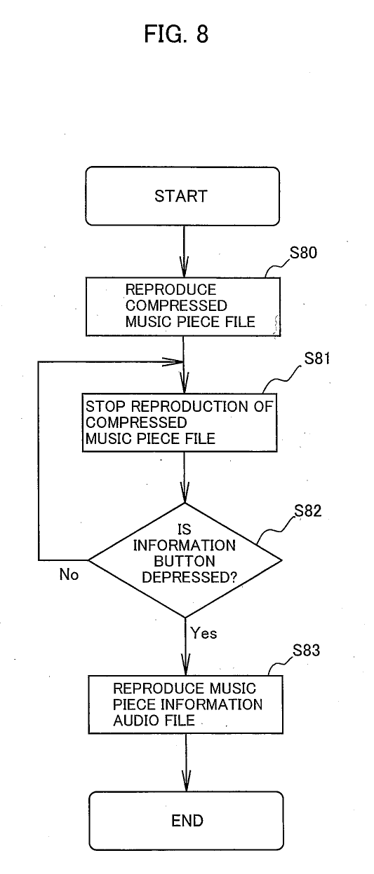

FIG. 8 is a flow chart showing an operation for reproducing the music piece information audio file in a phase of stop of the reproduction of the compressed music piece file in the audio reproducing apparatus according to the embodiment of the invention.

Firstly, the compressed music piece file 602 is reproduced (Step S80). Next, when the user depresses the information button 102e (Step S82: YES) during stop of the reproduction of the compressed music piece file 602 (Step S81), the control portion 204 reproduces the music piece information audio file 603 associated with the compressed music piece file 602 from the management information file 601 (Step S83), thereby completing this operation.

On the other hand, when the user depresses no information button 102e in Step S82 (Step S82: NO), the operation returns back to the processing in Step S81.

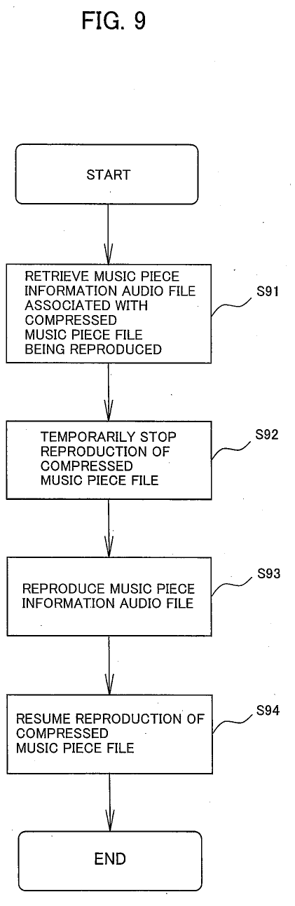

FIG. 9 is a flow chart showing an operation for reproducing the music piece information auto file in a phase of the reproduction of the compressed music piece file in the audio reproducing apparatus according to the embodiment of the invention.

When the user depresses the information button 102e, the control portion 204 retrieves the music piece information audio file 603 associated with the compressed music piece file 602 which is currently being reproduced from the management information file 601 (Step S91). After completion of the retrieval for the music piece information audio file 603, the control portion 204 temporarily stops the reproduction of the compressed music piece file 602 (Step S92). After temporary stop of the reproduction of the compressed music piece file 602, the control portion 204 reproduces the music piece information audio file 603 thus retrieved (Step S93). After completion of the reproduction of the music piece information audio file 603, the control portion resumes the reproduction of the compressed music piece file 602 (Step S94).

According to the above-mentioned embodiment of the invention, even under the situation in which the user cannot look at the picture on the displaying portion 101 of the audio reproducing apparatus 10, he/she can obtain the desired information of a compressed music piece file at a desired arbitrary time.

It should be noted that the present invention is not limited to the embodiment described above, and the various combinations and changes may be made without departing from or changing the technical idea of the present invention.

What is claimed is:

1. An audio reproducing apparatus, comprising:
a communicating portion for transmitting/receiving a music piece file, and a music piece information audio file having audio information, music piece information accompanying the music piece file being converted into the audio information;
a memory portion for storing therein the music piece file and the music piece information audio file;
a reproducing portion for reproducing the music piece file and the music piece information audio file, and outputting a resulting regenerative signal; and
a sound outputting portion for outputting the regenerative signal in a form of a sound.

2. An audio reproducing apparatus according to claim 1, wherein the reproducing portion reproduces audio information into which at least one of a music piece name, an album title, an artist name and the like of a music piece is converted in a form of the music piece information audio file.

3. An audio reproducing apparatus according to claim 1, wherein the reproducing portion reproduces the music piece information audio file in an arbitrary timing, that is, before the reproduction of the music piece file, during the reproduction of the music piece file or after the reproduction of the music piece file.

4. An audio reproducing apparatus according to claim 1, wherein the communicating portion receives the music piece file from an external computer, and receives the music piece information audio file which is generated from the music piece file in the external computer.

5. An audio reproducing apparatus, comprising:
a communicating portion for transmitting/receiving a music piece file having, and a music piece information audio file having audio information, music piece information accompanying the music piece file being converted into the audio information;
a memory portion for storing therein the music piece file and the music piece information audio file;
a music piece information-reproducing button, an instruction to reproduce the music piece information audio file being issued by using the music piece information-reproducing button;
a reproducing portion for reproducing the music piece file, and reproducing the music piece information audio file in accordance with the instruction for reproduction, thereby outputting a regenerative signal; and
a sound outputting portion for outputting the regenerative signal in a form of a sound.

6. An audio reproducing apparatus according to claim 5, wherein the reproducing portion reproduces audio information into which at least one of a music piece name, an album title, an artist name and the like of a music piece is converted in a form of the music piece information audio file.

7. An audio reproducing apparatus according to claim 5, wherein the reproducing portion reproduces the music piece information audio file by manipulating the music piece information-reproducing button during the reproduction of the music piece file.

8. An audio reproducing apparatus according to claim 5, wherein the reproducing portion reproduces the music piece information audio file by manipulating the music piece information-reproducing button during stop of the reproduction of the music piece file.

9. An audio reproducing apparatus according to claim 5, wherein the reproducing portion reproduces audio information into which at least one of a music piece name, an album title, an artist name and the like of a music piece is converted in a form of the music piece information audio file by manipulating the music piece information-reproducing button during the reproduction of the music piece file.

10. An audio reproducing apparatus according to claim 5, wherein the reproducing portion reproduces audio information into which at least one of a music piece name, an album title, an artist name and the like of a music piece is converted-in a form of the music piece information audio file by manipulating the music piece information-reproducing button during stop of the reproduction of the music piece file.

11. An audio reproducing apparatus according to claim 5, wherein the communicating portion receives the music piece file from an external computer, and receives the music piece information audio file which is generated from the music piece file in the external computer.

12. An audio reproducing apparatus, comprising:
a communicating portion for transmitting/receiving a music piece file, and a music piece information audio file through a communication with an external computer, the music piece information audio file being generated in accordance with the music piece file in the external computer and having audio information, music piece information on the music piece file-being converted into the audio information;
a memory portion for storing therein the music piece file and the music piece information audio file;
a music piece information-reproducing button, an instruction to reproduce the music piece information audio file being issued by using the music piece information-reproducing button;
a reproducing portion for reproducing the music piece file and the music piece information audio file in accordance with the instruction for reproduction, thereby outputting a regenerative signal; and
a sound outputting portion for outputting the regenerative signal in a form of a sound.

13. An audio reproducing apparatus according to claim 12, wherein the reproducing portion reproduces audio information into which at least one of a music piece name, an album title, an artist name and the like of a music piece is converted in a form of the music piece information audio file.

14. An audio reproducing apparatus according to claim 12, wherein the reproducing portion reproduces the music piece information audio file by manipulating the music piece information-reproducing button during the reproduction of the music piece file.

15. An audio reproducing apparatus according to claim 12, wherein the reproducing portion reproduces the music piece information audio file by manipulating the music piece information-reproducing button during stop of the reproduction of the music piece file.

16. An audio reproducing apparatus according to claim 12, wherein the reproducing portion reproduces audio information into which at least one of a music piece name, an album title, an artist name and the like of a music piece is converted in a form of the music piece information audio file by manipulating the music piece information-reproducing button during the reproduction of the music piece file.

17. An audio reproducing apparatus according to claim 12, wherein the reproducing portion reproduces audio information into which at least one of a music piece name, an album title, an artist name and the like of a music piece is converted in a form of the music piece information audio file by manipulating the music piece information-reproducing button during stop of the reproduction of the music piece file.

18. An audio reproducing apparatus according to claim 12, wherein the external computer acquires character information having music piece information on the music piece file, and converts the character information into audio information, thereby generating the music piece information audio file.
